(19) United States
(12) Patent Application Publication
(10) Pub. No.: US 2025/0241479 A1
(43) Pub. Date: Jul. 31, 2025

(54) TEA CANISTER FOR BUBBLE TEA MACHINE

(71) Applicant: Dongguan ZEEWAY-Technology Ltd, Guangdong Province (CN)

(72) Inventors: Mengyi Zhu, Guangdong Province (CN); Liang Zhou, Guangdong Province (CN)

(73) Assignee: Dongguan ZEEWAY-Technology Ltd, Guangdong Province (CN)

(21) Appl. No.: 18/955,958

(22) Filed: Nov. 21, 2024

(30) Foreign Application Priority Data
Jan. 26, 2024 (CN) 2024202080438

(51) Int. Cl. A47J 31/46

(52) U.S. Cl. CPC A47J 31/461; A47J 31/462

(57) ABSTRACT

The present disclosure discloses a tea canister for a bubble tea machine, mounted on the bubble tea machine, comprises a tea canister body, a three-way valve, a quick connector and a manual drain valve. The three-way valve is mounted on the lower side of the tea canister body; the manual drain valve and the quick connector are mounted in the three-way valve, respectively; and the three-way valve is communicated with the tea canister body, the quick connector and the manual drain valve, respectively. The above tea canister for bubble tea machine is communicated with the tea canister body, the quick connector and the manual drain valve through the three-way valve respectively. Such configuration can be used to automatically dispense a quantitative ingredient from the tea canister body through the bubble tea machine, so as to automatically dispense the ingredients for making the bubble tea, while the ingredient can be dispensed through operation of the manual drain valve as needed to satisfy different demands for dispensing of ingredients.

### TECHNICAL FIELD

The present disclosure relates to the technical field of bubble tea machines, in particular, to a tea canister for bubble tea machines.

### BACKGROUND

Bubble tea machine is widely used in most bubble tea shops. The common bubble tea machine on the market is decentralized, that is, one kind of raw ingredient corresponds to a dispensing port. The operator needs to operate different dispensing port according to different bubble tea recipes. Therefore, when the bubble tea recipe involves more ingredients, the operator needs to change the station of the tea cup many times for the proportioning of the operation. In this case, on the one hand, for the operators' proficiency has a high requirement, and they need to memorize all the recipes of the bubble tea; on the other hand, the constant changing of station leads to lower efficiency of making bubble tea; and in the peak period, the orders cannot be completed in time.

Therefore, there exists an integrated automatic bubble tea machine in the current market in iteration, which integrates most of stations, and delivers ingredients from different tea canisters to the same one dispensing port of the same station through hoses, so as to realize automated bubble tea making and improve the efficiency. Temperature of the tea canister in this configuration will be lowered after a long period of time, resulting in changes in taste of the bubble tea. The above automatic bubble tea machine can only dispense quantitative ingredients, resulting in that manual temperature testing can only be conducted by dispensing the quantitative ingredients, resulting in a large amount of waste of the dispensed ingredients. In order to solve the above problem, a temperature sensor generally is added into the tea canister and a display is added on outer side of the tea canister, so that the temperature in the tea canister is displayed on the display for reference of the operators. However, wires of such configuration are required to penetrate the tea canister, resulting in a decline in heat insulation of the tea canister, a risk of ingredient leakage, and higher costs of the tea canister and higher costs of bubble tea machine.

### SUMMARY

A main purpose of the present disclosure is to provide a tea canister for a bubble tea machine, in order to solve the above technical problems, which can enable the tea canister to dispense ingredient as required.

In order to realize the above purpose, the present disclosure adopts the following technical solutions:

A tea canister for a bubble tea machine, mounted on the bubble tea machine. comprises a tea canister body, a three-way valve, a quick connector and a manual drain valve. The three-way valve is mounted on the lower side of the tea canister body. the manual drain valve and the quick connector is mounted in the three-way valve respectively. The three-way valve is communicated with the tea canister body, the quick connector and the manual drain valve, respectively.

As a preferred technical solution, the quick connector comprises a quick connector female seat and a quick connector male seat. The quick connector female seat is mounted on the three-way valve. The quick connector male seat is mounted on the piping system of the bubble tea maker. The quick connector female seat is connected against the quick connector male seat.

As a preferred technical solution, the manual drain valve comprises a handle and a water outlet component. The water outlet component communicates with the three-way valve. The handle is mounted on the water outlet component.

The beneficial effect of the present disclosure is in that: the above tea canister for bubble tea machine is communicated with the tea canister body, the quick connector and the manual drain valve through the three-way valve respectively. Such configuration can be used to automatically dispense a quantitative ingredient from the tea canister body through the bubble tea machine, so as to automatically dispense the ingredient for making the bubble tea, while the ingredient can be dispensed through operation of the manual drain valve as needed to satisfy the different demands for dispensing of ingredients.

### BRIEF DESCRIPTION OF FIGURES

FIG. 1 shows a schematic view of structure of a tea canister for a bubble tea machine according to the present disclosure;

FIG. 2 shows a sectional view of a tea canister for a bubble tea machine according to the present disclosure.

### DETAILED DESCRIPTION

In order to make the purposes, technical solutions and advantages of the present disclosure clearer, detailed description is provided further in combination with the accompanying drawings and embodiments. It should be understood that the specific embodiments described herein are only for explaining the present disclosure and are not intended to limit the present disclosure.

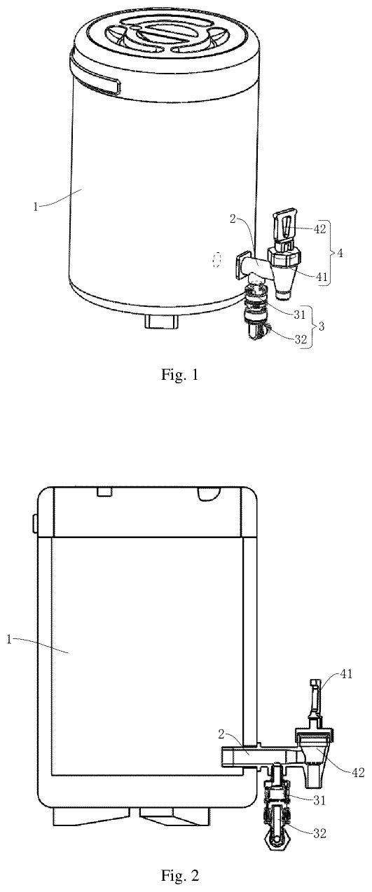

As shown in FIGS. 1 and 2, a tea canister for a bubble tea machine is mounted on the bubble tea machine, comprising a tea canister body 1, a three-way valve 2, a quick connector 3 and a manual drain valve 4. The three-way valve 2 is mounted on the lower side of the tea canister body 1. The manual drain valve 4 and the quick connector 3 are mounted in the three-way valve 2, respectively. The three-way valve 2 is communicated with the tea canister body 1, the quick connector 3 and the manual drain valve 4, respectively. The quick connector 3 is communicated with a piping system of the bubble tea machine. Such configuration can be used to automatically dispense quantitative ingredient from the tea canister body 1 through the bubble tea machine, so as to automatically dispense the ingredients for making the bubble tea; while the ingredients can be dispensed through operation of the manual drain valve 4 to satisfy the different demands for dispensing ingredients.

Specifically, the quick connector 3 includes a quick connection female seat 31 and a quick connection male seat 32. The quick connection female seat 31 is mounted on the three-way valve 2. The quick connection male seat 32 is mounted on the piping system of the bubble tea machine. The quick connection female seat 31 is connected against the quick connection male seat32, so that the bubble tea machine is able to dispense quantitative ingredient from the quick connector 3 through the piping system. When the ingredient runs out and the tea canister has to be changed, the quick connection male seat 32 is disassembled from the quick connection female seat 31, so that the tea canister is disassembled from the bubble tea machine. When assembled, the tea canister is directly placed on the bubble tea machine and the quick connection male seat 32 is installed into the quick connection female seat 31, thereby realizing quick disassembly and assembly.

Specifically, the manual drain valve 4 includes a handle 41 and a water outlet component 42. The water outlet component 42 is communicated with the three-way valve 2. The handle 41 is installed on the water outlet component 42. The water outlet component 42 is turned on when operates the handle 41, so that the ingredient is dispensed from the water outlet component 42. When it is necessary to refill a beverage, it is possible to directly operate the handle 41, so that an ingredient is dispensed from the water outlet component 42. When the bubble tea machine is in fault and cannot dispense the ingredient from the quick connector 3, an operator can also directly operate the handle 41 to dispense the ingredient from the water outlet component 42. Therefore, it is not delayed for making of the bubble tea and it is ensured that the bubble tea can be made on time.

The above mentioned embodiments are only better examples of the present disclosure, not to limit the scope of the present disclosure. Therefore, any equivalent changes or modifications made in accordance with the structure, features and principles described in the scope of the present disclosure should be included in the scope of the present disclosure.

What is claimed is:

1. A tea canister for a bubble tea machine, mounted on the bubble tea machine, comprising a tea canister body, a three-way valve, a quick connector and a manual drain valve;
Wherein the three-way valve is mounted on the lower side of the tea canister body; the manual drain valve and the quick connector are mounted in the three-way valve, respectively; and the three-way valve is communicated with the tea canister body, the quick connector and the manual drain valve, respectively.

2. A tea canister for a bubble tea machine of claim 1, wherein the quick connector comprises a quick connection female seat and a quick connection male seat, wherein the quick connection female seat is mounted on the three-way valve; the quick connection male seat is mounted on a piping system of the bubble tea machine; and the quick connection female seat is connected against the quick connection male seat.

3. A tea canister for a bubble tea machine of claim 2, wherein the manual drain valve comprises a handle and a water outlet component; the water outlet component communicates with the three-way valve; and he handle is mounted on the water outlet component.
